(19) United States
(12) Patent Application Publication
(10) Pub. No.: US 2026/0038510 A1
(43) Pub. Date: Feb. 5, 2026

(54) MULTI-DIMENSIONAL VOICE QUALITY ANALYSIS TO DETECT FRAUD

(71) Applicant: Capital One Services, LLC, McLean, VA (US)

(72) Inventors: Benjamin RAPPOPORT, Chevy Chase, MD (US); Helena STAAL, Alexandria, VA (US); Hang NGUYEN, Vienna, VA (US)

(21) Appl. No.: 18/791,782

(22) Filed: Aug. 1, 2024

(51) Int. Cl. G10L 17/26; G06F 21/56; G10L 17/02; G10L 25/63; G10L 25/90

(52) U.S. Cl. CPC G10L 17/26; G06F 21/566; G10L 17/02; G10L 25/63; G10L 25/90; G06F 2221/034

(57) ABSTRACT

In some implementations, a voice analysis system may receive, from a telecommunications system, an audio stream associated with a user. The voice analysis system may provide the audio stream to a machine learning model in order to receive a plurality of indicators associated with the audio stream. The plurality of indicators may be associated with a pitch of the user, a tone of the user, a speaking rate of the user, an emotional state of the user, or a vocabulary of the user. The voice analysis system may estimate whether the audio stream is associated with fraud based on the plurality of indicators. The voice analysis system may transmit, to an administrator device, an indication of whether the audio stream is associated with fraud.

### BACKGROUND

Phone and video calls with customers are often recorded. Storing recordings of phone and video calls increases storage overhead as well as consuming power and processing resources.

### SUMMARY

Some implementations described herein relate to a system for detecting fraud using multi-dimensional voice analysis. The system may include one or more memories and one or more processors communicatively coupled to the one or more memories. The one or more processors may be configured to receive a plurality of voice recordings associated with a user. The one or more processors may be configured to generate a first set of matrices, from the plurality of voice recordings, associated with a pitch or a tone of the user. The one or more processors may be configured to generate a second set of matrices, from the plurality of voice recordings, associated with a speaking rate of the user. The one or more processors may be configured to generate a third set of matrices, from the plurality of voice recordings, associated with an emotional baseline of the user. The one or more processors may be configured to generate a fourth set of matrices, from a plurality of transcripts of the plurality of voice recordings, associated with a vocabulary of the user. The one or more processors may be configured to provide the first set of matrices, the second set of matrices, the third set of matrices, and the fourth set of matrices to a machine learning model. The one or more processors may be configured to receive an audio stream associated with the user. The one or more processors may be configured to provide the audio stream to the machine learning model in order to receive a plurality of indicators associated with the audio stream. The one or more processors may be configured to determine that the audio stream is associated with fraud based on the plurality of indicators. The one or more processors may be configured to output, to an administrator device, an alert indicating that the audio stream is associated with fraud.

Some implementations described herein relate to a method of detecting fraud using multi-dimensional voice analysis. The method may include receiving, from a telecommunications system and at a voice analysis system, an audio stream associated with a user. The method may include providing, by the voice analysis system, the audio stream to a machine learning model in order to receive a plurality of indicators associated with the audio stream, wherein the plurality of indicators are associated with a pitch of the user, a tone of the user, a speaking rate of the user, an emotional state of the user, or a vocabulary of the user. The method may include estimating, by the voice analysis system, whether the audio stream is associated with fraud based on the plurality of indicators. The method may include transmitting, from the voice analysis system and to an administrator device, an indication of whether the audio stream is associated with fraud.

Some implementations described herein relate to a non-transitory computer-readable medium that stores a set of instructions for detecting fraud using multi-dimensional voice analysis. The set of instructions, when executed by one or more processors of a device, may cause the device to transmit, to a voice analysis system, a request to assess an audio stream associated with a user. The set of instructions, when executed by one or more processors of the device, may cause the device to receive, from the voice analysis system, a plurality of indicators associated with the audio stream, wherein the plurality of indicators correspond to a plurality of dimensions of a voice profile associated with the user. The set of instructions, when executed by one or more processors of the device, may cause the device to transmit a request for fraud prevention instructions in response to the plurality of indicators. The set of instructions, when executed by one or more processors of the device, may cause the device to receive the fraud prevention instructions in response to the request for the fraud prevention instructions.

### BRIEF DESCRIPTION OF THE DRAWINGS

FIGS. 1A-1C are diagrams of an example implementation relating to multi-dimensional voice quality analysis to detect fraud, in accordance with some embodiments of the present disclosure.

FIG. 2 is a diagram of example multi-dimensional comparisons between audio stream indicators and voice profiles, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIGS. 5-6 are flowcharts of example processes relating to multi-dimensional voice quality analysis to detect fraud, in accordance with some embodiments of the present disclosure.

### DETAILED DESCRIPTION

The following detailed description of example implementations refers to the accompanying drawings. The same reference numbers in different drawings may identify the same or similar elements.

An organization that conducts phone and video calls often records those calls. Recordings increase storage overhead as well as consuming power and processing resources. In order to utilize phone and video call recordings, managers may review the recordings in order to identify areas for improvement for employees.

Machine learning models may be applied to recordings in order to try and automatically determine areas for improvement for employees. However, these models are usually trained on features general to all recordings. As a result, these models are unable to identify features specific to customers in the recordings.

Some implementations described herein enable use of machine learning to construct profiles for users on voice (and video) calls. For example, a machine learning model may establish baselines (and/or ranges) for a pitch of a user, a tone of the user, a speaking rate of the user, an emotional state of the user, and/or a vocabulary of the user, among other examples. Therefore, a profile of the user may be used to determine when an artificial voice (designed to mimic the user) is being used to conduct fraud or when the user is under duress (e.g., because they are calling to conduct a transaction as instructed by a scammer who threatened the user). As a result, automated intervention may be performed in order to prevent the fraud, and thus to increase security and conserve power and processing resources that otherwise would have been wasted in working to undo the fraud.

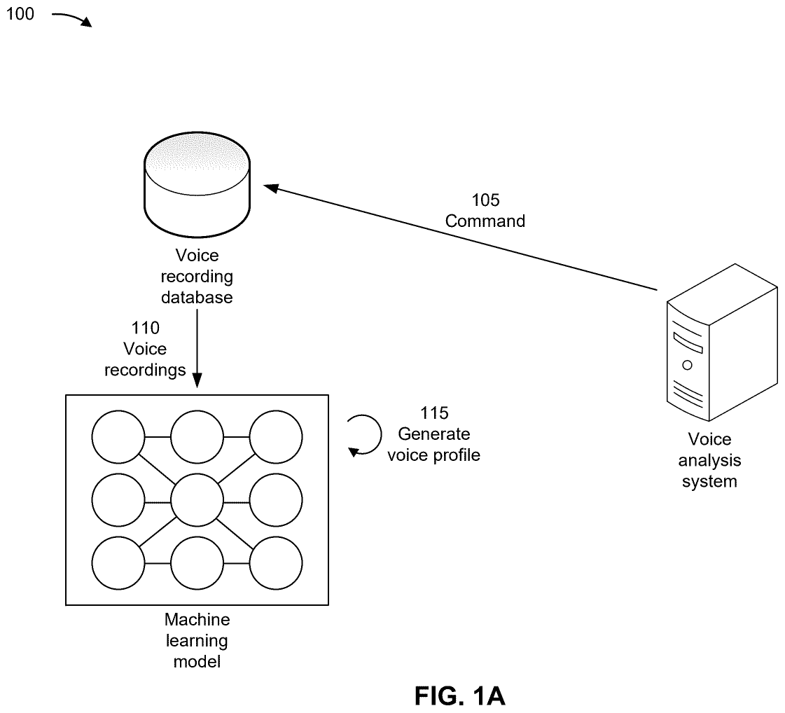

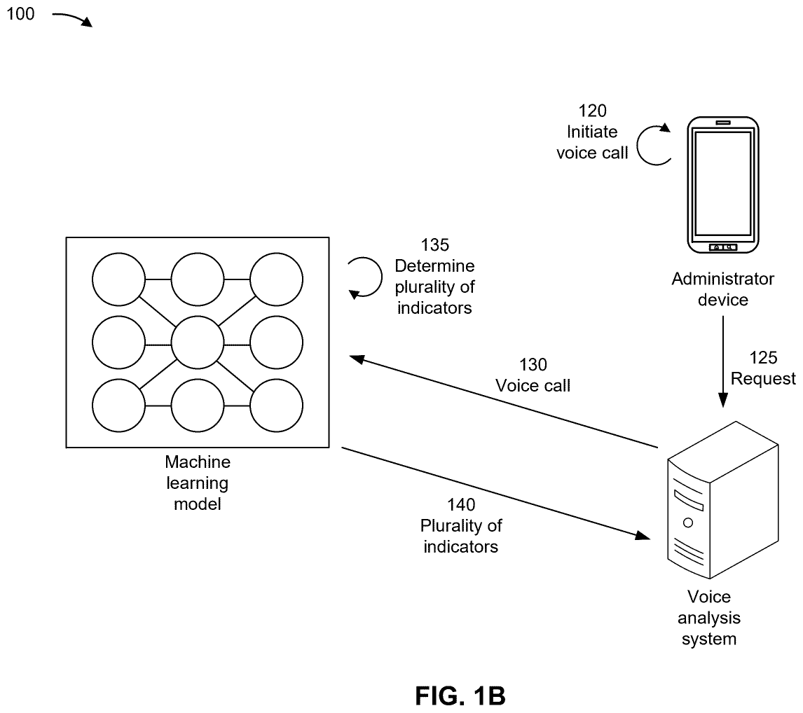

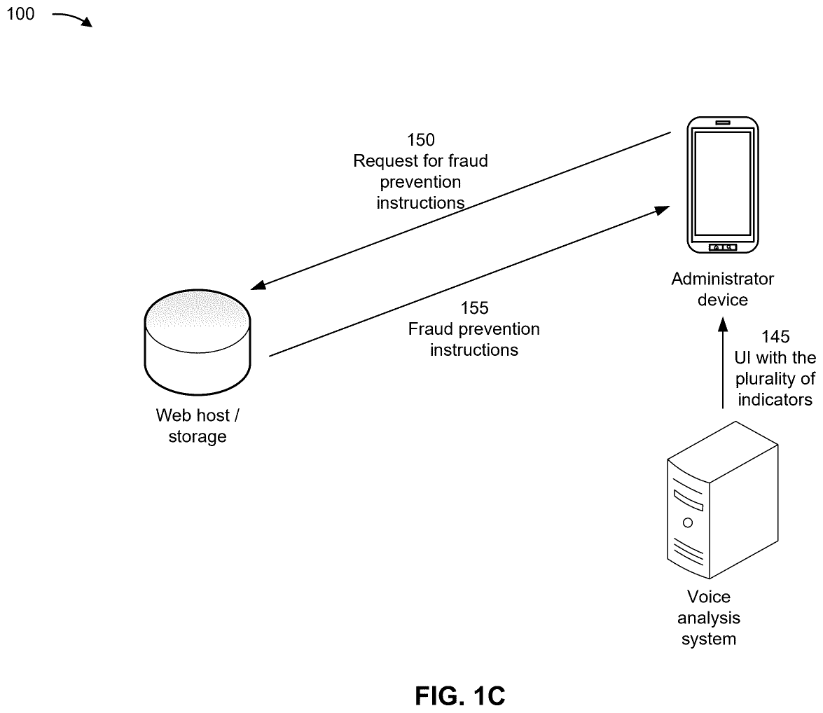

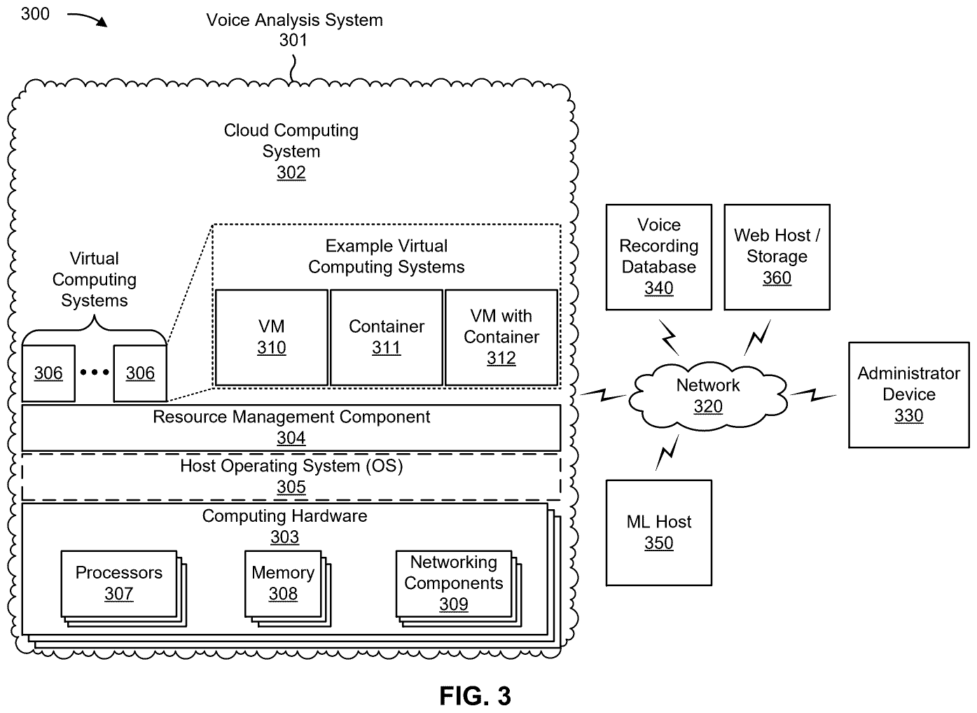

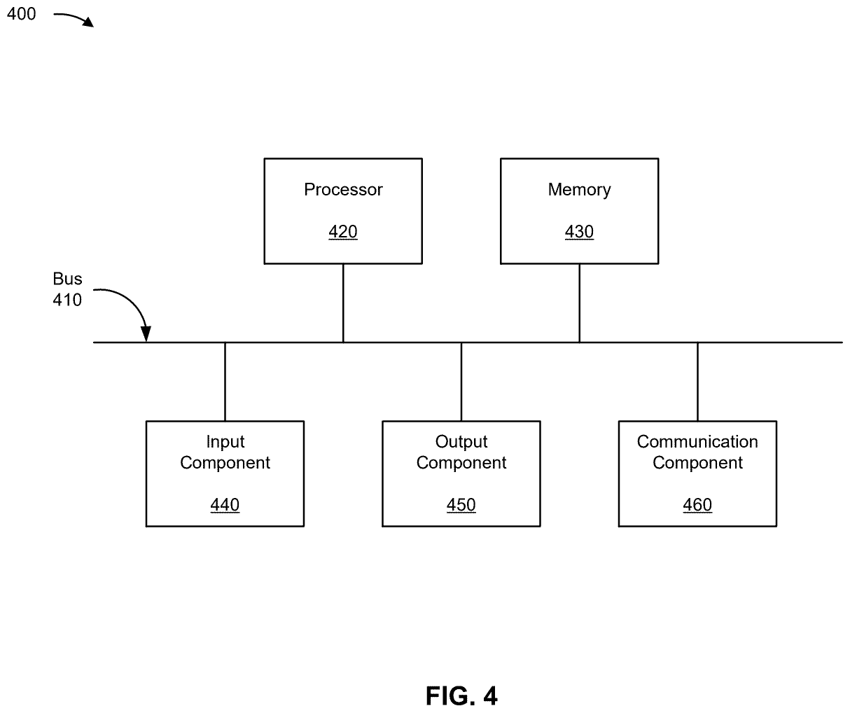

FIGS. 1A-1C are diagrams of an example 100 associated with multi-dimensional voice quality analysis to detect fraud. As shown in FIGS. 1A-1C, example 100 includes a voice analysis system, a voice recording database, a machine learning (ML) model (e.g., provided by an ML host), an administrator device, and a web host or storage (shown as “web host/storage”). These devices are described in more detail in connection with FIGS. 3 and 4.

As shown in FIG. 1A and by reference number 105, the voice analysis system may transmit, and the voice recording database may receive, a command to provide a plurality of voice recordings (e.g., to train the ML model). The command may be a hypertext transfer protocol (HTTP) message, a file transfer protocol (FTP) message, and/or an application programming interface (API) call. The command may include (e.g., in a header and/or as an argument) an indication of the plurality of voice recordings (e.g., filenames and/or filepaths associated with the plurality of voice recordings, among other examples). Additionally, or alternatively, the command may include (e.g., in a header and/or as an argument) an indication of a user (e.g., a name, a username, an email address, and/or an account number, among other examples), and the plurality of voice recordings may all be associated with the user. Therefore, the voice analysis system may transmit the command in order to generate a voice profile associated with the user.

As shown by reference number 110, the voice recording database may transmit, and the ML model may receive, the plurality of voice recordings. For example, the voice recording database may transmit, and the ML host (associated with the ML model) may receive, the plurality of voice recordings. The voice recording database may retrieve the plurality of voice recordings based on the indication (of the plurality of voice recordings and/or of the user, as described above) included in the command. For example, the voice recording database may retrieve each voice recording using a corresponding filename (and/or filepath) included in the indication. In another example, the voice recording database may execute a query with the user included in the indication and receive the plurality of voice recordings in response to the query.

As shown by reference number 115, the ML model may generate the voice profile (associated with the user) based on the plurality of voice recordings. For example, the ML host (associated with the ML model) may convert the plurality of voice recordings into matrices and provide the matrices as input to the ML model. Accordingly, the ML model may output the voice profile based on the matrices.

In some implementations, the ML host may generate a first set of matrices, from the plurality of voice recordings, associated with a pitch or a tone of the user. For example, the first set of matrices may encode numerical representations of the pitch and/or the tone. Additionally, or alternatively, the ML host may generate a second set of matrices, from the plurality of voice recordings, associated with a speaking rate of the user. For example, the second set of matrices may include words per minute (wpm) (e.g., based on transcripts generated from the plurality of voice recordings), phonemes per second (e.g., based on portions of the plurality of voice recordings that are isolated to the user rather than other speakers), and/or another measurement of speaking rate and/or articulation rate. Additionally, or alternatively, the ML host may generate a third set of matrices, from the plurality of voice recordings, associated with an emotional baseline of the user. For example, the ML host may use a dictionary-based or corpus-based model to determine the emotional baseline using transcripts generated from the plurality of voice recordings and/or may use pattern recognition to determine the emotional baseline using portions of the plurality of voice recordings that are isolated to the user rather than other speakers. Therefore, the third set of matrices may encode numerical representations of the emotional baseline. Additionally, or alternatively, the ML host may generate a fourth set of matrices, from the plurality of voice recordings, associated with a vocabulary of the user. For example, the ML host may identify common words spoken by the user using transcripts generated from the plurality of voice recordings. Therefore, the fourth set of matrices may encode strings or tokens representing the common words.

The ML model may output the voice profile based on the sets of matrices. For example, the ML model may output a plurality of baselines for a plurality of dimensions, each baseline being associated with a corresponding dimension in the plurality of dimensions. The dimensions may be associated with a pitch of the user, a tone of the user, a speaking rate of the user, an emotional state of the user, and/or a vocabulary of the user, among other examples. Additionally, or alternatively, the ML model may output a plurality of confidence intervals for the plurality of dimensions, each confidence interval being associated with a corresponding dimension in the plurality of dimensions.

In some implementations, the ML host may transmit, and the voice analysis system may receive, an indication that the voice profile, associated with the user, has been generated. In some implementations, the voice recording database (e.g., rather than the ML host) may transmit, and the voice analysis system may receive, the indication. The indication may include an HTTP message, an FTP message, and/or a return from a call to an API function (e.g., provided by, or at least associated with, the ML host or the voice recording database).

Although the example 100 is described in connection with the ML host generating the voice profile, other examples may include the voice analysis system (at least partially) generating the voice profile. For example, the voice analysis system may generate the sets of matrices from the plurality of voice recordings, as described above, and may transmit the sets of matrices to the ML model (e.g., via the ML host). In another example, the voice analysis system may be at least partially integrated (e.g., physically, logically, and/or virtually) with the ML host, and thus may directly apply the ML model to generate the voice profile.

In some implementations, the ML model may store the voice profile (e.g., at the ML host). Additionally, or alternatively, the voice recording database may store the voice profile. Additionally, or alternatively, the voice analysis system may store the voice profile. In any implementation described above, the voice profile may be stored in association with an identifier of the user. Accordingly, the voice profile may be retrieved using the identifier of the user. The identifier may include the indication of the user, as described above, and/or an anonymized identifier created for the user (e.g., by the ML host, the voice recording database, and/or the voice analysis system).

As shown in FIG. 1B and by reference number 120, the administrator device may initiate a (voice or video) call (e.g., with a user device associated with the user). The administrator device may use a telecommunications system to initiate and manage the call. The telecommunications system may use one or more wired and/or wireless networks. For example, the telecommunications system may use a cellular network (e.g., a fifth generation (5G) network, a fourth generation (4G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The telecommunications system may include one or more devices capable of receiving, processing, storing, routing, and/or providing traffic (e.g., a packet and/or other information or metadata) in a manner described herein. For example, the telecommunications system may include a router, such as a label switching router (LSR), a label edge router (LER), an ingress router, an egress router, a provider router (e.g., a provider edge router or a provider core router), a virtual router, or another type of router. Additionally, or alternatively, the telecommunications system may include a gateway, a switch, a firewall, a hub, a bridge, a reverse proxy, a server (e.g., a proxy server, a cloud server, or a data center server), a load balancer, and/or a similar device. In some implementations, the telecommunications system may include a physical device implemented within a housing, such as a chassis. In some implementations, the telecommunications system may include a virtual device implemented by one or more computing devices of a cloud computing environment or a data center. In some implementations, the telecommunications system may include a group of devices, such as a group of data center nodes that are used to route traffic flow through a network.

As shown by reference number 125, the administrator device may transmit, and the voice analysis system may receive, a request to assess an audio stream associated with the user. The audio stream may be from the call between the administrator device and the user device. The request may be an HTTP request, an FTP request, and/or an API call.

In some implementations, the administrator device may transmit, and the voice analysis system may receive, a set of credentials that authorize the voice analysis system to access the audio stream. For example, the request may include the set of credentials. In another example, the voice analysis system may transmit (and the administrator device may receive) a prompt for the set of credentials in response to the request to assess the audio stream, and the administrator device may transmit (and the voice analysis system may receive) the set of credentials in response to the prompt. The set of credentials may include a username and password, a passkey, a secret answer, a certificate, a private key, a token, and/or biometric information, among other examples.

In some implementations, the administrator device may transmit the request to assess the audio stream in response to input from an administrator using the device. For example, the administrator may interact with a user interface (UI) (e.g., output using an output component of the administrator device), and the interaction may trigger the administrator device to transmit the request. Alternatively, the administrator device may transmit the request automatically in response to connecting the administrator device to the call (e.g., a phone call or a video call) with the user (e.g., as described in connection with reference number 120).

The voice analysis system may receive the audio stream from the administrator device. For example, the administrator device may duplicate audio data that is received (e.g., from the telecommunications system) and/or generated (e.g., by an input component of the administrator device) as part of the call. Accordingly, the administrator device may stream the duplicated audio data to the voice analysis system. Alternatively, the voice analysis system may receive the audio stream directly from the telecommunications system. For example, one or more components of the telecommunications system may duplicate audio data transmitted as part of the call and may stream the duplicated audio data to the voice analysis system.

As shown by reference number 130, the voice analysis system may provide the audio stream to the ML model. For example, the voice analysis system may transmit, and the ML host (associated with the ML model) may receive, a request including the audio stream. The ML model may be trained (e.g., by the ML host and/or a device at least partially separate from the ML host) to compare audio streams to voice profiles. The ML model may be trained using audio streams that are labeled by administrators or other types of users (e.g., for supervised learning). Additionally, or alternatively, the ML model may be trained using audio streams that are unlabeled (e.g., for deep learning). The ML model may be configured to determine a plurality of indicators associated with an audio stream (e.g., by comparing the audio stream to a corresponding voice profile). Additionally, or alternatively, the ML model may be configured to determine a probability that fraud is present (e.g., based on a probability that the audio stream is associated with an artificial voice and/or a probability that the audio stream is associated with a user who is under duress). Accordingly, fraud may be detected as present (or not) based on whether the probability satisfies a fraud threshold.

In some implementations, the ML model may include a regression algorithm (e.g., linear regression or logistic regression), which may include a regularized regression algorithm (e.g., Lasso regression, Ridge regression, or Elastic-Net regression). Additionally, or alternatively, the ML model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., information about front-end devices). For example, for a regression algorithm, a model parameter may include a regression coefficient (e.g., a weight). For a decision tree algorithm, a model parameter may include a decision tree split location, as an example.

Additionally, the ML host (and/or a device at least partially separate from the ML host) may use one or more hyperparameter sets to tune the ML model. A hyperparameter may include a structural parameter that controls execution of a machine learning algorithm by the ML host, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

As shown by reference number 135, the ML model may determine the plurality of indicators. For example, the ML model may compare the audio stream to the voice profile of the user in order to determine the plurality of indicators. In some implementations, the voice profile may be stored by the ML host and may be retrieved (e.g., using an indication of the user in the request from the voice analysis system). Alternatively, the voice profile may be provided by the voice analysis system (e.g., with the request to the ML host). Alternatively, the ML host may request the voice profile from the voice recording database (e.g., using an indication of the user in the request from the voice analysis system) and may receive the voice profile from the voice recording database in response.

As shown by reference number 140, the ML model may output the plurality of indicators. For example, the voice analysis system may receive the plurality of indicators from the ML model (e.g., from the ML host). The plurality of indicators, associated with the audio stream, may include indicators associated with a pitch of the user, a tone of the user, a speaking rate of the user, an emotional state of the user, and/or a vocabulary of the user, among other examples. The plurality of indicators may represent differences (in the audio stream) from baselines (in the voice profile) for a plurality of dimensions. Additionally, or alternatively, the plurality of indicators may represent differences (in the audio stream) from confidence intervals (in the voice profile) for the plurality of dimensions.

Although the example 100 is described in connection with applying the ML model to the audio stream, other examples may include applying the ML model to sets of matrices (e.g., as described above) derived from the audio stream. For example, the voice analysis system may calculate sets of matrices, as described above, from the audio stream and may provide the sets of matrices to the ML model (e.g., via the ML host). In another example, the ML host may calculate the sets of matrices from the audio stream and may input the sets of matrices to the ML model.

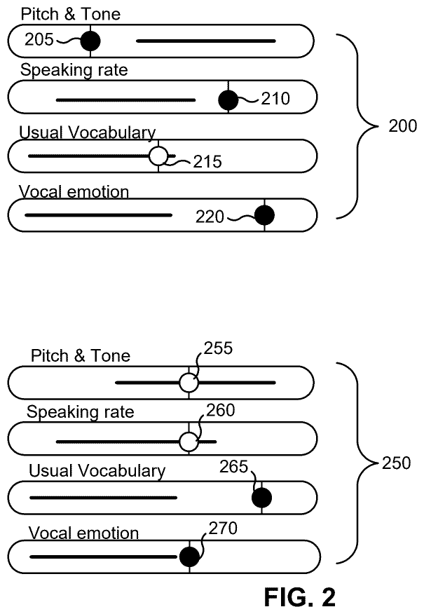

As shown in FIG. 1C and by reference number 145, the voice analysis system may transmit, and the administrator device may receive, instructions for a UI representing the plurality of indicators. For example, the UI may be as described in connection with FIG. 2. Additionally, or alternatively, the voice analysis system may transmit, and the administrator device may receive, the plurality of indicators associated with the audio stream (e.g., in a log file and/or as raw numbers for processing and/or output by the administrator device).

In some implementations, the voice analysis system may further estimate whether the audio stream is associated with fraud based on the plurality of indicators. The voice analysis system may transmit, and the administrator device may receive, an indication of whether the audio stream is associated with fraud (e.g., as part of a same UI representing the plurality of indicators or separately). In one example, the voice analysis system may determine that the audio stream is associated with fraud based on the plurality of indicators (e.g., based on the plurality of indicators satisfying one or more conditions associated with fraud). In some implementations, one or more indicators, in the plurality of indicators, may satisfy a fraud threshold. Accordingly, the voice analysis system may determine that the audio stream is associated with fraud based on the fraud threshold being satisfied and/or based on a quantity of the indicator(s) that satisfy the fraud threshold satisfying an indicator threshold. The voice analysis system may transmit, and the administrator device may receive, an alert indicating that the audio stream is associated with fraud. The alert may include a push notification and/or an email message, among other examples.

In some implementations, the voice analysis may determine whether the audio stream is likely artificial. The voice analysis system may transmit, and the administrator device may receive, an indication of whether the audio stream is likely artificial (e.g., as part of a same UI representing the plurality of indicators or separately). In one example, the voice analysis system may determine that the audio stream may be artificial based on the plurality of indicators (e.g., based on the plurality of indicators satisfying one or more conditions associated with artificiality). In some implementations, one or more indicators, in the plurality of indicators, may satisfy an artificiality threshold. Accordingly, the voice analysis system may determine that the audio stream may be artificial based on the artificiality threshold being satisfied and/or based on a quantity of the indicator(s) that satisfy the artificiality threshold satisfying an indicator threshold. The voice analysis system may transmit, and the administrator device may receive, an alert indicating that the audio stream may be artificial. The alert may include a push notification and/or an email message, among other examples.

Additionally, or alternatively, the voice analysis may determine whether the user is likely under duress. The voice analysis system may transmit, and the administrator device may receive, an indication of whether the user is likely under duress (e.g., as part of a same UI representing the plurality of indicators or separately). In one example, the analysis system may determine that the user may be under duress based on the plurality of indicators (e.g., based on the plurality of indicators satisfying one or more conditions associated with duress). In some implementations, one or more indicators, in the plurality of indicators, may satisfy a duress threshold. Accordingly, the voice analysis system may determine that the user may be under duress based on the duress threshold being satisfied and/or based on a quantity of the indicator(s) that satisfy the duress threshold satisfying an indicator threshold. The voice analysis system may transmit, and the administrator device may receive, an alert indicating that the user may be under duress. The alert may include a push notification and/or an email message, among other examples.

Although the example 100 is described using a static analysis, other examples may include a dynamic analysis. For example, the ML model may periodically update the plurality of indicators as the call continues and the audio stream is (or updated sets of matrices derived from the audio stream are) provided to the ML model. Accordingly, the voice analysis system may output updates to the plurality of indicators (and/or to a UI representing the plurality of indicators). Additionally, or alternatively, the voice analysis system may output an alert, as described above, only after an amount of time has passed (during which the plurality of indicators continue to indicate fraud, even as the plurality of indicators are updated) that satisfies a hysteresis threshold.

The administrator of the administrator device may react accordingly based on the plurality of indicators and/or an alert, as described above. For example, based on a determination of artificiality, the administrator may request additional identifying information from the user or may terminate a transaction in progress (and optionally terminate the call as well). Alternatively, the voice analysis system may automatically terminate the transaction (and/or the call) based on the determination of artificiality. In another example, based on a determination of duress, the administrator may ask additional questions to determine if the user has been instructed by a scammer. Alternatively, the voice analysis system may automatically terminate a transaction in progress based on the determination of duress.

The administrator may additionally, or alternatively, request more information, For example, in some implementations, and as shown by reference number 150, the administrator device may transmit, and the web host/storage may receive, a request for fraud prevention instructions. The administrator device may transmit, and the web host/storage may receive, the request in response to the plurality of indicators.

In some implementations, the fraud prevention instructions may be included in an employee manual, and the request may be a request for the employee manual. The administrator device may transmit the request in response to interaction with the UI including the plurality of indicators (e.g., as described in connection with reference number 145). For example, the administrator may click or tap a button of the UI, may speak a voice command, or may otherwise interact with the UI to trigger the administrator device to request the employee manual.

Additionally, or alternatively, the fraud prevention instructions may be included in a webpage, whether on an intranet or publicly available (e.g., on the Internet), and the request may be an HTTP request. The administrator device may transmit the request in response to interaction with a hyperlink (e.g., included in a UI including the plurality of indicators, as described in connection with reference number 145, or otherwise output by the administrator device). The interaction may trigger the administrator device to transmit the HTTP request.

As shown by reference number 155, the web host/storage may transmit, and the administrator device may receive, the fraud prevention instructions. For example, the web host/storage may transmit, and the administrator device may receive, the fraud prevention instructions in response to the request from the administrator device. The fraud prevention instructions may be included in the employee manual and/or the webpage, as described above.

By using techniques as described in connection with FIGS. 1A-1C, the voice profile of the user (e.g., associated with a pitch of the user, a tone of the user, a speaking rate of the user, an emotional state of the user, and/or a vocabulary of the user, among other examples) is used to determine when the audio stream is likely artificial and/or when the user is likely under duress. As a result, fraud that otherwise would have been conducted on the call may be prevented, and thus security is increased, and power and processing resources are conserved that otherwise would have been wasted in working to undo the fraud.

As indicated above, FIGS. 1A-1C are provided as an example. Other examples may differ from what is described with regard to FIGS. 1A-1C.

FIG. 2 is a diagram of examples 200 and 250 associated with multi-dimensional comparisons between audio stream indicators and voice profiles. As shown in FIG. 2, the example 200 may include a first indicator 205 associated with a pitch and a tone of the user in an audio stream. In the example 200, the indicator 205 shows that the pitch and the tone are below a confidence interval indicated in a voice profile of the user. Therefore, the indicator 205 is colored to indicate that the pitch and the tone are outside of the confidence interval. Example 200 further includes a second indicator 210 associated with a speaking rate of the user in the audio stream. In the example 200, the indicator 210 shows that the speaking rate is above a confidence interval indicated in the voice profile of the user. Therefore, the indicator 210 is colored to indicate that the speaking rate is outside of the confidence interval. As further shown in FIG. 2, the example 200 may include a third indicator 215 associated with a vocabulary of the user in the audio stream. In the example 200, the indicator 215 shows that the vocabulary is within the confidence interval indicated in the voice profile of the user. Therefore, the indicator 220 is uncolored to indicate that the vocabulary is within the confidence interval. Example 200 further includes a fourth indicator 220 associated with an emotion of the user in the audio stream. In the example 200, the indicator 220 shows that the emotion is above a confidence interval indicated in the voice profile of the user. Therefore, the indicator 220 is colored to indicate that the emotion is outside of the confidence interval.

The example 200 may be associated with fraud. In particular, the example 200 may be associated with the user under duress. In particular, the user is speaking faster than usual with an elevated pitch and tone and heightened emotion. Therefore, the user may be acting on instructions of a scammer that has threatened the user.

On the other hand, the example 250 may include a first indicator 255 associated with a pitch and a tone of the user in an audio stream. In the example 250, the indicator 255 shows that the pitch and the tone are within a confidence interval indicated in a voice profile of the user. Therefore, the indicator 255 is uncolored to indicate that the pitch and the tone are within the confidence interval. Example 250 further includes a second indicator 260 associated with a speaking rate of the user in the audio stream. In the example 250, the indicator 260 shows that the speaking rate is within a confidence interval indicated in the voice profile of the user. Therefore, the indicator 260 is uncolored to indicate that the speaking rate is within the confidence interval. As further shown in FIG. 2, the example 250 may include a third indicator 265 associated with a vocabulary of the user in the audio stream. In the example 250, the indicator 265 shows that the vocabulary is above a confidence interval indicated in the voice profile of the user. Therefore, the indicator 265 is colored to indicate that the vocabulary is outside of the confidence interval. Example 250 further includes a fourth indicator 270 associated with an emotion of the user in the audio stream. In the example 250, the indicator 270 shows that the emotion is (slightly) above a confidence interval indicated in the voice profile of the user. Therefore, the indicator 270 is colored to indicate that the emotion is outside of the confidence interval.

The example 250 may be associated with fraud. In particular, the example 250 may be associated with artificiality. In particular, the user's voice is being mimicked, but the vocabulary is (highly) unusual for the user. Therefore, a scammer may be using artificial intelligence to try and conduct fraud by posing as the user.

As indicated above, FIG. 2 is provided as an example. Other examples may differ from what is described with regard to FIG. 2.

FIG. 3 is a diagram of an example environment 300 in which systems and/or methods described herein may be implemented. As shown in FIG. 3, environment 300 may include a voice analysis system 301, which may include one or more elements of and/or may execute within a cloud computing system 302. The cloud computing system 302 may include one or more elements 303-312, as described in more detail below. As further shown in FIG. 3, environment 300 may include a network 320, an administrator device 330, a voice recording database 340, an ML host 350, and/or a web host or storage (shown as “web host/storage”) 360. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the voice analysis system 301 may include one or more elements 303-312 of the cloud computing system 302, may execute within the cloud computing system 302, and/or may be hosted within the cloud computing system 302, in some implementations, the voice analysis system 301 may not be cloud-based (e.g., may be implemented outside of a cloud computing system) or may be partially cloud-based. For example, the voice analysis system 301 may include one or more devices that are not part of the cloud computing system 302, such as device 400 of FIG. 4, which may include a standalone server or another type of computing device. The voice analysis system 301 may perform one or more operations and/or processes described in more detail elsewhere herein.

The network 320 may include one or more wired and/or wireless networks. For example, the network 320 may include a cellular network, a PLMN, a LAN, a WAN, a private network, the Internet, and/or a combination of these or other types of networks. The network 320 enables communication among the devices of the environment 300.

The administrator device 330 may include one or more devices capable of receiving, generating, storing, processing, and/or providing information associated with audio streams, as described elsewhere herein. The administrator device 330 may include a communication device and/or a computing device. For example, the administrator device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The administrator device 330 may communicate with one or more other devices of environment 300, as described elsewhere herein.

The voice recording database 340 may be provided by one or more devices capable of receiving, generating, storing, processing, and/or providing information associated with voice recordings, as described elsewhere herein. The voice recording database 340 may be provided by a communication device and/or a computing device. For example, the voice recording database 340 may be provided by a server, a database server, an application server, a client server, a web server, a host server, a proxy server, a virtual server (e.g., executing on computing hardware), a server in a cloud computing system, a device that includes computing hardware used in a cloud computing environment, or a similar type of device. The voice recording database 340 may communicate with one or more other devices of environment 300, as described elsewhere herein.

The ML host 350 may include one or more devices capable of receiving, generating, storing, processing, and/or providing information associated with machine learning models, as described elsewhere herein. The ML host 350 may include a communication device and/or a computing device. For example, the ML host 350 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 350 may communicate with one or more other devices of environment 300, as described elsewhere herein.

The web host/storage 360 may include one or more devices capable of receiving, generating, storing, processing, and/or providing information associated with files and/or webpages, as described elsewhere herein. The web host/storage 360 may include a communication device and/or a computing device. For example, the web host/storage 360 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The web host/storage 360 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with multi-dimensional voice quality analysis to detect fraud. The device 400 may correspond to an administrator device 330, a device implementing a voice recording database 340, an ML host 350, and/or a web host/storage 360. In some implementations, an administrator device 330, a device implementing a voice recording database 340, an ML host 350, and/or a web host/storage 360 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

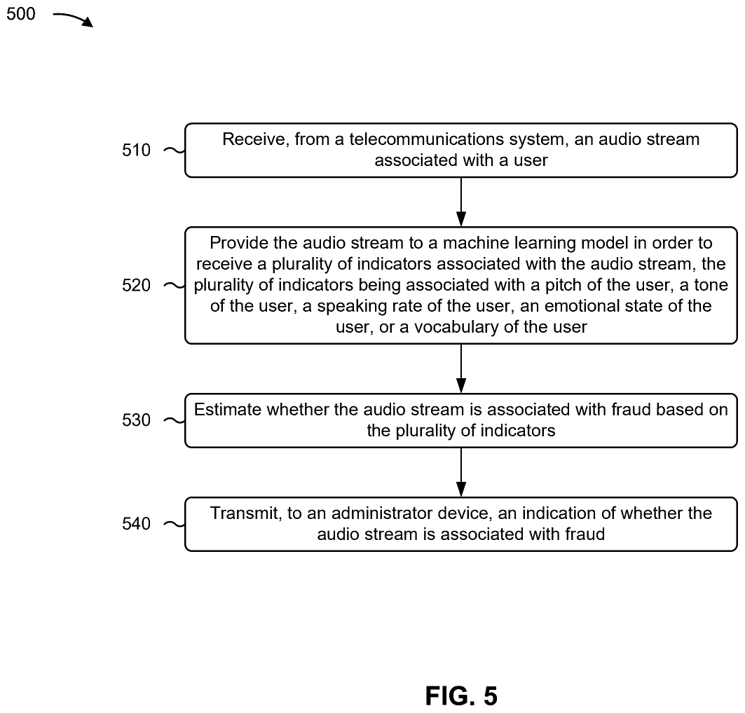

FIG. 5 is a flowchart of an example process 500 associated with multi-dimensional voice quality analysis to detect fraud. In some implementations, one or more process blocks of FIG. 5 may be performed by a voice analysis system 301. In some implementations, one or more process blocks of FIG. 5 may be performed by another device or a group of devices separate from or including the voice analysis system 301, such as an administrator device 330, a device implementing a voice recording database 340, an ML host 350, and/or a web host/storage 360. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a telecommunications system, an audio stream associated with a user (block 510). For example, the voice analysis system 301 (e.g., using processor 420, memory 430, and/or communication component 460) may receive, from a telecommunications system, an audio stream associated with a user, as described above in connection with FIG. 1B. As an example, the voice analysis system 301 may receive (e.g., from an administrator device) a set of credentials that authorize the voice analysis system 301 to access the audio stream. Therefore, the voice analysis system 301 may request and receive (from the telecommunications system) the audio stream using the set of credentials.

As further shown in FIG. 5, process 500 may include providing the audio stream to a machine learning model in order to receive a plurality of indicators associated with the audio stream, the plurality of indicators being associated with a pitch of the user, a tone of the user, a speaking rate of the user, an emotional state of the user, or a vocabulary of the user (block 520). For example, the voice analysis system 301 (e.g., using processor 420, memory 430, and/or communication component 460) may provide the audio stream to a machine learning model in order to receive a plurality of indicators associated with the audio stream, the plurality of indicators being associated with a pitch of the user, a tone of the user, a speaking rate of the user, an emotional state of the user, or a vocabulary of the user, as described above in connection with FIG. 1B. As an example, the voice analysis system 301 may transmit a request, including the audio stream, to an ML host associated with the machine learning model. Therefore, the voice analysis system may receive the plurality of indicators (e.g., from the ML host) in response to the request.

As further shown in FIG. 5, process 500 may include estimating whether the audio stream is associated with fraud based on the plurality of indicators (block 530). For example, the voice analysis system 301 (e.g., using processor 420 and/or memory 430) may estimate whether the audio stream is associated with fraud based on the plurality of indicators, as described above in connection with FIG. 1C. As an example, the voice analysis system 301 may determine whether the audio stream is associated with fraud based on whether the plurality of indicators satisfy one or more conditions associated with fraud. In one example, one or more indicators, in the plurality of indicators, may satisfy a fraud threshold. Accordingly, the voice analysis system 301 may determine that the audio stream is associated with fraud based on the fraud threshold being satisfied and/or based on a quantity of the indicator(s) that satisfy the fraud threshold satisfying an indicator threshold.

As further shown in FIG. 5, process 500 may include transmitting, to an administrator device, an indication of whether the audio stream is associated with fraud (block 540). For example, the voice analysis system 301 (e.g., using processor 420, memory 430, and/or communication component 460) may transmit, to an administrator device, an indication of whether the audio stream is associated with fraud, as described above in connection with FIG. 1C. As an example, the indication may be included in a UI. Additionally, or alternatively, the indication may be included in an alert.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C and/or FIG. 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

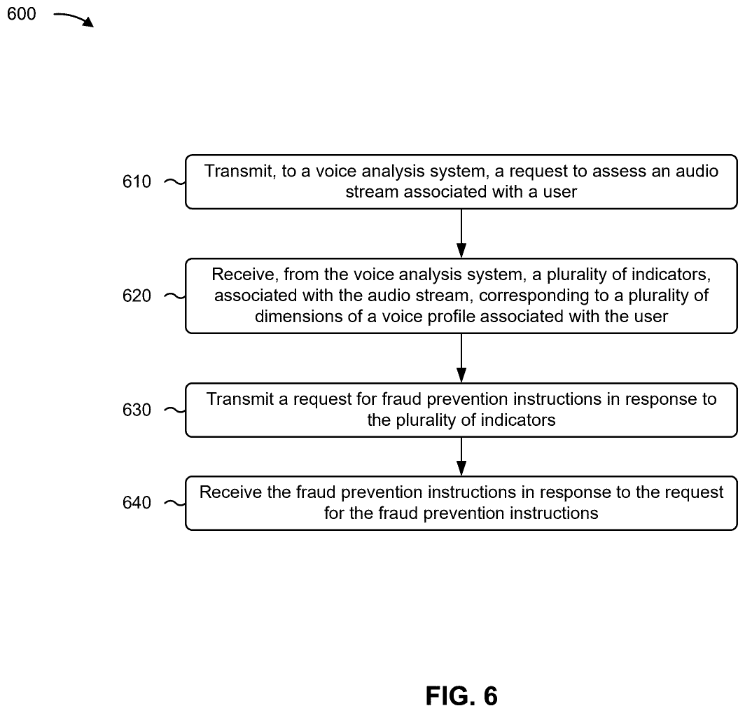

FIG. 6 is a flowchart of an example process 600 associated with multi-dimensional voice quality analysis to detect fraud. In some implementations, one or more process blocks of FIG. 6 may be performed by an administrator device 330. In some implementations, one or more process blocks of FIG. 6 may be performed by another device or a group of devices separate from or including the administrator device 330, such as a voice analysis system 301, a device implementing a voice recording database 340, an ML host 350, and/or a web host/storage 360. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting, to a voice analysis system, a request to assess an audio stream associated with a user (block 610). For example, the administrator device 330 (e.g., using processor 420, memory 430, and/or communication component 460) may transmit, to a voice analysis system, a request to assess an audio stream associated with a user, as described above in connection with reference number 125 of FIG. 1B. As an example, the audio stream may be from a call between the administrator device 330 and a user device of the user. The request may be an HTTP request, an FTP request, and/or an API call.

As further shown in FIG. 6, process 600 may include receiving, from the voice analysis system, a plurality of indicators, associated with the audio stream, corresponding to a plurality of dimensions of a voice profile associated with the user (block 620). For example, the administrator device 330 (e.g., using processor 420, memory 430, and/or communication component 460) may receive, from the voice analysis system, a plurality of indicators, associated with the audio stream, corresponding to a plurality of dimensions of a voice profile associated with the user, as described above in connection with reference number 145 of FIG. 1C. As an example, the plurality of indicators may be included in a UI. Additionally, or alternatively, the plurality of indicators may be included in another indication from the voice analysis system.

As further shown in FIG. 6, process 600 may include transmitting a request for fraud prevention instructions in response to the plurality of indicators (block 630). For example, the administrator device 330 (e.g., using processor 420, memory 430, and/or communication component 460) may transmit a request for fraud prevention instructions in response to the plurality of indicators, as described above in connection with reference number 150 of FIG. 1C. As an example, the request may be a request for an employee manual. Additionally, or alternatively, the request may be an HTTP request.

As further shown in FIG. 6, process 600 may include receiving the fraud prevention instructions in response to the request for the fraud prevention instructions (block 640). For example, the administrator device 330 (e.g., using processor 420, memory 430, input component 440, and/or communication component 460) may receive the fraud prevention instructions in response to the request for the fraud prevention instructions, as described above in connection with reference number 155 of FIG. 1C. As an example, the fraud prevention instructions may be included in an employee manual and/or a webpage.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1C and/or FIG. 2. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for detecting fraud using multi-dimensional voice analysis, the system comprising:
one or more memories; and
one or more processors, communicatively coupled to the one or more memories, configured to:
receive a plurality of voice recordings associated with a user;
generate a first set of matrices, from the plurality of voice recordings, associated with a pitch or a tone of the user;
generate a second set of matrices, from the plurality of voice recordings, associated with a speaking rate of the user;
generate a third set of matrices, from the plurality of voice recordings, associated with an emotional baseline of the user;
generate a fourth set of matrices, from a plurality of transcripts of the plurality of voice recordings, associated with a vocabulary of the user;
provide the first set of matrices, the second set of matrices, the third set of matrices, and the fourth set of matrices to a machine learning model;
receive an audio stream associated with the user;
provide the audio stream to the machine learning model in order to receive a plurality of indicators associated with the audio stream;
determine that the audio stream is associated with fraud based on the plurality of indicators; and
output, to an administrator device, an alert indicating that the audio stream is associated with fraud.

2. The system of claim 1, wherein the one or more processors, to determine that the audio stream is associated with fraud, are configured to:
determine that the audio stream may be artificial based on the plurality of indicators satisfying one or more conditions.

3. The system of claim 2, wherein the alert further indicates that the audio stream may be artificial.

4. The system of claim 1, wherein the one or more processors, to determine that the audio stream is associated with fraud, are configured to:
determine that the user may be under duress based on the plurality of indicators satisfying one or more conditions.

5. The system of claim 4, wherein the alert further indicates that the user may be under duress.

6. The system of claim 1, wherein the one or more processors, to provide the first set of matrices, the second set of matrices, the third set of matrices, and the fourth set of matrices to the machine learning model, are configured to:
transmit the first set of matrices, the second set of matrices, the third set of matrices, and the fourth set of matrices to a machine learning host associated with the machine learning model; and
receive, from the machine learning host, an indication that a voice profile, associated with the user, has been generated.

7. The system of claim 1, wherein the one or more processors, to provide the audio stream to the machine learning model, are configured to:
transmit the audio stream to a machine learning host associated with the machine learning model; and
receive, from the machine learning host, the plurality of indicators in response to the audio stream.

8. A method of detecting fraud using multi-dimensional voice analysis, comprising:
receiving, from a telecommunications system and at a voice analysis system, an audio stream associated with a user;
providing, by the voice analysis system, the audio stream to a machine learning model in order to receive a plurality of indicators associated with the audio stream, wherein the plurality of indicators are associated with a pitch of the user, a tone of the user, a speaking rate of the user, an emotional state of the user, or a vocabulary of the user;
estimating, by the voice analysis system, whether the audio stream is associated with fraud based on the plurality of indicators; and
transmitting, from the voice analysis system and to an administrator device, an indication of whether the audio stream is associated with fraud.

9. The method of claim 8, wherein the machine learning model is associated with a voice profile associated with the user.

10. The method of claim 8, wherein each indicator, in the plurality of indicators, represents a difference from a baseline for a corresponding dimension in a plurality of dimensions.

11. The method of claim 8, wherein each indicator, in the plurality of indicators, represents a difference from a confidence interval for a corresponding dimension in a plurality of dimensions.

12. The method of claim 8, wherein estimating whether the audio stream is associated with fraud comprises:
determining whether the audio stream is likely artificial; or
determining whether the user is likely under duress.

13. The method of claim 8, further comprising:
transmitting, from the voice analysis system and to the administrator device, instructions for a user interface representing the plurality of indicators.

14. A non-transitory computer-readable medium storing a set of instructions for detecting fraud using multi-dimensional voice analysis, the set of instructions comprising:
one or more instructions that, when executed by one or more processors of a device, cause the device to:
transmit, to a voice analysis system, a request to assess an audio stream associated with a user;
receive, from the voice analysis system, a plurality of indicators associated with the audio stream, wherein the plurality of indicators correspond to a plurality of dimensions of a voice profile associated with the user;
transmit a request for fraud prevention instructions in response to the plurality of indicators; and
receive the fraud prevention instructions in response to the request for the fraud prevention instructions.

15. The non-transitory computer-readable medium of claim 14, wherein the one or more instructions, that cause the device to transmit the request to assess the audio stream, cause the device to:
transmit, to the voice analysis system, a set of credentials that authorize the voice analysis system to access the audio stream.

16. The non-transitory computer-readable medium of claim 14, wherein the one or more instructions, that cause the device to transmit the request to assess the audio stream, cause the device to:
transmit the audio stream to the voice analysis system.

17. The non-transitory computer-readable medium of claim 14, wherein the one or more instructions, that cause the device to transmit the request to assess the audio stream, cause the device to:
transmit the request in response to input from an administrator using the device.

18. The non-transitory computer-readable medium of claim 14, wherein the one or more instructions, that cause the device to transmit the request to assess the audio stream, cause the device to:
transmit the request automatically in response to connecting the device to a phone call or a video call with the user.

19. The non-transitory computer-readable medium of claim 14, wherein the one or more instructions, that cause the device to transmit the request for fraud prevention instructions, cause the device to:
transmit a request for an employee manual in response to interaction with a user interface including the plurality of indicators.

20. The non-transitory computer-readable medium of claim 14, wherein the one or more instructions, that cause the device to transmit the request for fraud prevention instructions, cause the device to:
transmit a hypertext transfer protocol request in response to interaction with a hyperlink associated with the plurality of indicators.
